(19) United States
(12) Patent Application Publication
(10) Pub. No.: US 2003/0074277 A1
(43) Pub. Date: Apr. 17, 2003

(54) Method and apparatus for automatically reviewing application information and preparing responsive communications

(76) Inventor: Gregory L. Foutz, Gilbert, AZ (US)

Correspondence Address: Schwegman, Lundberg, Woessner & Kluth, P.A., P.O. Box 2938, Minneapolis, MN, 55402, US

(21) Appl. No.: 10/272,396

(22) Filed: Oct. 16, 2002

Related U.S. Application Data
(60) Provisional application No. 60/329,905, filed on Oct. 16, 2001.

(51) Int. Cl. G06F 17/60

(52) U.S. Cl. 705/26

(57) ABSTRACT

A method for application processing enables a user to submit an application for a product (204, FIG. 2) using a first computer (102, FIG. 1). The application information is sent to a second computer (106) for processing. The first and second computers could be a client and server, respectively. An automatic review process (206, FIG. 2) is performed, by evaluating (804, FIG. 8) the application information in light of one or more rule sets. Each rule set can correspond to a potential provider of the requested product, in one embodiment. If the application information fits the criteria of one or more rule sets (806), then information for an automatic review communication (ARC) is generated and stored (808). After a review of the ARC information, in one embodiment, the ARC is sent to the user or the user is otherwise informed of the ARC's existence. In one embodiment, the application is an application for insurance, the automatic review process is an automatic underwriting process for one or more potential insurance providers, and the ARC is an insurance quote or bid. The method is implemented using client and server computers, which communicate over the Internet, in one embodiment.

### TECHNICAL FIELD OF THE INVENTION

The present invention relates generally to receiving and reviewing application information, and preparing responsive communications, and more particularly to a computer implemented method of receiving insurance application information, automatically performing underwriting, and preparing insurance quote information based on the results of the underwriting process.

### BACKGROUND OF THE INVENTION

In order to acquire many types of products (e.g., goods or services), it is often necessary for a potential customer to first provide information to the product provider. The information enables the provider to decide whether or not providing the product to the potential customer is a reasonable business risk.

For example, an individual (or company) who desires to obtain insurance usually must complete a paper application, disclosing the person's name, address, and other information (e.g., date of birth, social security number, occupation, prior insurance coverage, medical history, etc.). Using this information, one or more people employed by or acting on behalf of the insurance company (referred to below as a “representative”) perform a manual underwriting process, in which the representative makes a decision whether or not to offer the requested insurance to the individual. In some cases, the representative requires the individual to provide additional information or to submit to a medical examination during the underwriting process.

If insurance will be offered, a representative calculates a premium payment, and prepares a quote for the individual's review. If the quote appears accurate and acceptable to the individual, a representative prepares a contract. Once signed, the contract is binding, and coverage will be in force as of a specified coverage date.

The example process, above, includes the following tasks: 1) a potential customer submitting information via a paper application; 2) a representative manually reviewing the information in the application; 3) a representative rejecting or accepting the application based on certain criteria; and 4) in the case of acceptance, a representative preparing a document describing the offered product. Some or all of these tasks may also be performed, for example, when applying for utility services (e.g., telephone, cable, electricity, etc.), credit lines, loans, leases, and other tangible or intangible products.

Often, the above-described type of process takes days, weeks or even months to complete. The long cycle time is primarily due to the necessity for human involvement in the review, acceptance, and document preparation tasks. In addition, time is consumed when paper applications and other documents are physically transferred from one individual to another. In some cases, the length of time between submitting an application and receiving a notice of acceptance (or rejection) is unacceptably long, and may result in the loss of a potential customer. In addition, application throughput (i.e., the number of applications processed) is limited by the work capacity of a provider's available representatives. Because application throughput is limited by this factor, a provider may be forced to lower acceptance standards or to increase the number of available representatives. Both solutions can negatively impact the provider's profitability.

What is needed is a system and method for decreasing the cycle time for processes that include application, review, and acceptance/rejection tasks. Also needed is a system and method for increasing the application throughput for these types of processes, without increasing the number of representatives needed to perform the review and acceptance/rejection tasks. Further needed is a system and method that minimizes the amount of physical paper transfers required to accomplish these types of processes.

### BRIEF DESCRIPTION OF THE DRAWING

FIG. 1 illustrates a computer system in accordance with an embodiment of the invention;

FIG. 2 illustrates a flowchart of a method for submitting and reviewing application information in accordance with an embodiment of the invention;

FIG. 3 illustrates a flowchart of a method for registering a potential new user in accordance with an embodiment of the invention;

FIG. 4 illustrates a block diagram of example features available to a registered user in accordance with an embodiment of the invention;

FIG. 5 illustrates a block diagram of example features available to an administration-level user in accordance with an embodiment of the invention;

FIG. 6 illustrates an example of a system home page computer screen enabling a registered user and/or an administration-level user to initiate a feature of the system in accordance with an embodiment of the invention;

FIG. 7 illustrates a flowchart of a method for submitting a new application in accordance with an embodiment of the invention;

FIG. 8 illustrates a flowchart of a method for performing an automatic application review process in accordance with an embodiment of the invention;

FIG. 9 illustrates a flowchart of a method for tracking the status of an application in accordance with an embodiment of the invention;

FIG. 10 illustrates an example of a computer screen that displays an application selection page in accordance with an embodiment of the invention;

FIG. 11 illustrates an example of a computer screen that displays an application list in accordance with an embodiment of the invention;

FIG. 12 illustrates an example of a computer screen that displays an application form in accordance with an embodiment of the invention;

FIG. 13 illustrates a flowchart of a method for changing user information in accordance with an embodiment of the invention;

FIG. 14 illustrates a flowchart of a method for looking up information in accordance with an embodiment of the invention;

FIG. 15 illustrates a flowchart of a method for viewing commission information in accordance with an embodiment of the invention;

FIG. 16 illustrates a flowchart of a method for an administration-level user to view or change user information in accordance with an embodiment of the invention;

FIG. 17 illustrates a flowchart of a method for adding a new user in accordance with an embodiment of the invention;

FIG. 18 illustrates a flowchart of a method for viewing reports of user activity in accordance with an embodiment of the invention; and

FIG. 19 illustrates a flowchart of a method for assigning tasks to personnel in accordance with an embodiment of the invention.

### DETAILED DESCRIPTION OF THE INVENTION

In the following detailed description of the preferred embodiments, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that process or mechanical changes may be made without departing from the scope of the present invention. It will be recognized that portions of the methods of the various embodiments can be combined in practice, either concurrently or in succession. Various permutations and combinations will be readily apparent to those skilled in the art.

Terminology

As used in the description of the preferred embodiments, the following terms are defined as follows:

“Product” means one or more goods, services, or other tangible or intangible objects.

“Renewable Product” means a Product that is automatically terminated, revoked, or repossessible after a fixed period of time, on a fixed date or upon the occurrence of some event, unless an agreement to purchase the Product is renewed.

“Provider” means an individual, a group of individuals or a business entity that sells, provides, loans or leases one or more Products (including Renewable Products).

“Customer” means an individual, a group of individuals or a business entity that is, has or will receive a Product from a Provider.

“Potential Customer” means an individual, a group of individuals or a business entity that desires to, but has not yet, entered an agreement to receive a Product or Renewable Product from a Provider.

“Agent,” “Producer,” and “Broker” mean an individual or a business entity that acts on behalf of a Customer or Potential Customer. For example, but not by way of limitation, an Agent or Producer could be an insurance agent acting on behalf of a Potential Customer who desires to obtain insurance coverage. A Broker could be an individual or company that has a business relationship with multiple Agents, and which may or may not interact directly with Customers or Potential Customers.

“Application,” means one or more electronic files, web pages, or other entities, into which application information can be entered.

“Requester” means registered user, such as a Customer, Potential Customer, Agent or other representative, who submits application information.

“Application information” mean information, submitted by a Requester as part of an Application, or information that is generated in response to submitted information, and that is stored by the system or reviewed by the Review Processor in order to determine whether a Provider might supply a Product to a Customer or Potential Customer.

“Bid” and “Quote” mean information describing a Product that might be offered to a Customer or Potential Customer.

“Application Review Communication” or “ARC” mean a document, e-mail, letter or other communication, in electronic form, which includes a bid, a quote, an offer, a contract, an indication of an application's acceptance or rejection, or another written communication produced in response to an application review task.

“Underwriting” means a process of reviewing application information to determine whether and under what circumstances a Product will be offered to a Customer or Potential Customer. The use of the term in the detailed description is not meant to limit the scope of the application to the insurance industry. Instead, the term is meant to apply to review processes for all types of Products.

“Rule set” means a set of electronically-stored criteria that are used by a computer to make a decision for further action. A rule set may include application review rules specific to a particular Provider, or that apply to multiple Providers.

Description of the Embodiments

Various embodiments of the present invention provide a system and method for receiving application information, and automatically reviewing the information and making an acceptance or rejection decision. In one embodiment, the application information can be submitted electronically by a Requester at a client computer, which sends the information to a server over a network. The server, or another computer accessible to the server, acts as a review processor, and automatically makes an acceptance, rejection, or referral decision by reviewing the application information in light of one or more electronically-stored rule sets. In one embodiment, a rule set is associated with each of multiple potential Providers of a requested Product.

In one embodiment, the server automatically creates an Application Review Communication (ARC) or a communication that includes information in the ARC, and sends the ARC information to a reviewing individual, who is responsible for reviewing the information before sending the ARC to the Requester, or referring the application to one or more Providers. In another embodiment, the server sends the communication directly to the Requester, without an intermediate review process.

The description uses an example of electronically submitting and automatically reviewing an insurance application, and automatically generating an insurance quote based one or more sets of electronically-stored underwriting rules (e.g., the rule set). Accordingly, in the below-described example, the Product is insurance coverage. However, the system and method of the various embodiments can be used to automatically review information and generate responsive communications in conjunction with numerous other types of Products. For example, but not by way of limitation, embodiments of the invention could be used for applying for utility services (e.g., telephone, cable, electricity, etc.), extensions of credit, loans, leases, and other tangible or intangible Products. It would be obvious to one of skill in the art, based on the description herein, to modify the below-described embodiments to apply to these and other Products.

Prior art ways of evaluating insurance and other types of applications predominantly involve human efforts. In particular, prior art underwriting processes are performed by one or more individuals who manually review the application, apply underwriting criteria, make decisions regarding whether or not to offer coverage, and initiate quote or contract production. Prior art methods of evaluating other types of applications are similar, in regards to the level of human involvement in the process.

The method of the various embodiments has several significant advantages over these prior art methods. By automating the processes of application receipt, application review (e.g., underwriting), referral, and bid, the system and method of the various embodiments eliminate a substantial portion of the traditional manual processes and human intervention. This lowers the overall cost of doing business, and results in direct cost savings over the prior art methods. The improvement in the process achieved by the various embodiments significantly reduces cycle times, increases accuracy, and leads to a more profitable result.

In addition, the automated process is more convenient and efficient, in various embodiments. Because application submission, tracking, and information access is available online, in one embodiment, these tasks can be performed regardless of regular business hours, personnel availability or the quantity of business being performed. In addition, the automated application review process is much quicker than a human process. For an Agent or Broker, for example, this reduction in cycle time speeds the sale process to the end Customer, thus potentially increasing the amount of business brought forward and eliminating the need for costly sales personnel.

Another advantage to the various embodiments is that, by using computer-based application review (e.g., underwriting), the results obtained are much more predictable then when the prior-art, human version of the process is performed. There is no variability from person to person, and the automated process never makes decisions based on emotion or other human factors.

In one embodiment, the system has the ability to automate underwriting for more than one line of business services. For example, a Customer or Potential Customer might be interested in obtaining a combined quote for one or more types of insurance products, claims handling, payroll processing, other business accounting functions, human resource related tasks, and/or loss control functions. In one embodiment, the method is able to automate underwriting for each of these functions, and to produce a combined pricing model for presentation to the Customer or Potential Customer.

In addition, in one embodiment, various work flow checks and balances are included throughout the system, thus further decreasing the opportunities for human errors. For example, the system in one embodiment includes the ability to automatically send e-mail or electronic reminders of actions that need to be completed within certain time frames. This significantly reduces the likelihood that someone involved in the process will “drop the ball” and negatively impact the process flow or fail to realize the desired result.

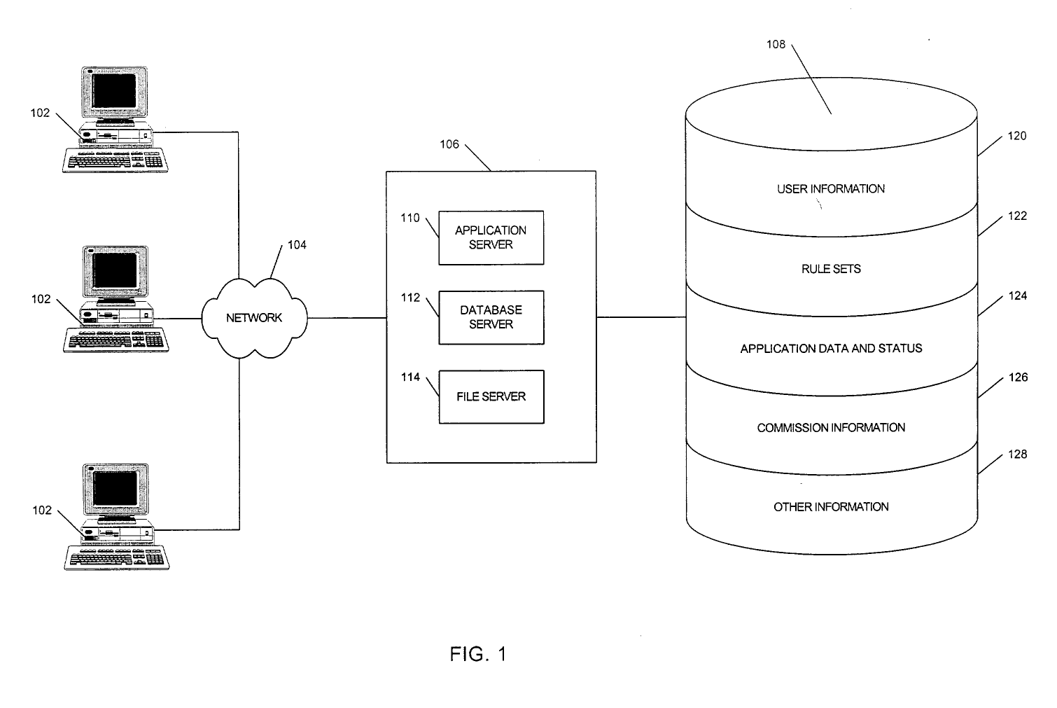

FIG. 1 illustrates a typical computer system within which the various embodiments of the present invention can be practiced. The system includes multiple client computers 102, each connected to one or more server computers 106 through one or more communication networks 104.

Client computers 102 could include, for example, stationary or portable personal computers (e.g., desktop or laptop computers). In addition, client computers 102 could include other devices that are capable of executing a browser and/or accessing a network through a wired or wireless connection. For example, client computers 102 could include handheld computing devices, pagers, specially-equipped television systems, and other types of devices.

Each client computer 102 includes one or more processors and one or more external network interfaces (e.g., ports). Each network interface allows a client computer 102 to send and receive messages from network 104. For example, a particular network interface could be an Ethernet port, fast Ethernet port, DSL port, or cable modem. In one embodiment, each network interface is a TCP/IP network interface, although other types of interfaces could be used, in other embodiments.

In one embodiment, each client computer 102 is capable of running one or more instances of a browser. As will be described in detail later, the browser enables the client computer 102 to prompt a Requester for information that will be automatically reviewed at the server in order to determine whether and under what conditions a Provider will offer a Product to a Customer or Potential Customer.

Server computer 106 could be, for example, one or more stationary desktop, mainframe, or other computing devices. Server computer 106 receives information from client computers 102 over the network 104, and accesses information, files, and data stored within a database 108. In one embodiment, an application server 110 resident on server 106 can execute scripts, which enable various screens to be displayed on client computers 102. A database server 112 resident on server 106 interacts with application server 110 to access database 108. In addition, a file server 114 resident on server 106 interacts with application server 110 to access files (e.g., HTML files) stored on server 110, database 108, or elsewhere.

In other embodiments, multiple servers 106 could be included in the system. Each of the multiple servers 106 could include an application server 110, database server 112, and file server 114. Alternatively, the application server 110, database server 112, and/or file server 114 could be implemented on separate server computers 106.

Each of the client and server computers 102, 106 are housed on one or more PC boards. In addition, each can include one or more microprocessors, busses, power supplies, storage medium, and one or more interfaces to outside networks. In one embodiment, each of these devices is coupled to bus, so that signals and power can be exchanged between devices. However, it is to be understood that in alternative embodiments, each of the devices could be coupled together through different busses.

The interfaces provide network connections between computers 102, 106 and one or more networks. Accordingly, the interfaces enable the exchange of messages between computers 102, 106 over a physical transmission medium that supports carrier wave transmissions. As will be described in more detail below, a client computer 102 sends requests and information to server 106 over the transmission medium, causing server 106 to perform various functions in accordance with embodiments of the invention. Server 106 sends files, information, and messages to client computer 102, causing client computer to display various screens in accordance with embodiments of the invention.

Besides executing the various embodiments on a general-purpose computer system, computer executable instructions for performing the methods of the various embodiments can be stored on one or more computer readable media. For example, such computer executable instructions can be stored on RAM, ROM, hard drive, CD, magnetic disk, disk drive, a combination of these types of storage media, and/or other types of storage media that are well known to those of skill in the art. In addition, a computer readable medium can include a medium having communications thereon for providing a computer with information, such as for example, the Internet, another type of network, or a carrier wave that transports information.

Network 104 could be any of various types of networks. For example, network 104 could be the Internet, a local area network (LAN), wide area network (WAN), Ethernet link, DSL system, telephone system or combinations of these or other types of networks. Although FIG. 1 illustrates each computer 102, 106 being interconnected with a single network 104, in other embodiments, each computer 102, 106 could be connected through different networks. For ease of illustration, only one network 104 is shown. In addition, although FIG. 1 implies hardwired connections between each computer 102, 106 and the network 104, wireless connections also could be implemented.

Database 108 can include one or more types of information storage devices. Some or all of database 108 can be resident on server computer 106, or can reside on one or more stand-alone computers (not shown). In one embodiment, database 108 is used to store user information 120, one or more rule sets 122, application data and status information 124, commission information 126, and other information 128. More or different information could be stored in database 108, in various other embodiments. In addition, the information could be distributed across more than one information storage device.

Embodiments of the invention are described in the context of a client/server system, such as that illustrated in FIG. 1. Alternatively, embodiments of the invention could be implemented in other types of systems. For example, application information could be entered directly into the same computer that performs the automatic review process. Basically, in accordance with embodiments of the invention, the system includes an application information input means, an information review means, and a communication means. The locations of these elements on specific computers can be modified based on the type of computer system on which embodiments of the invention are implemented.

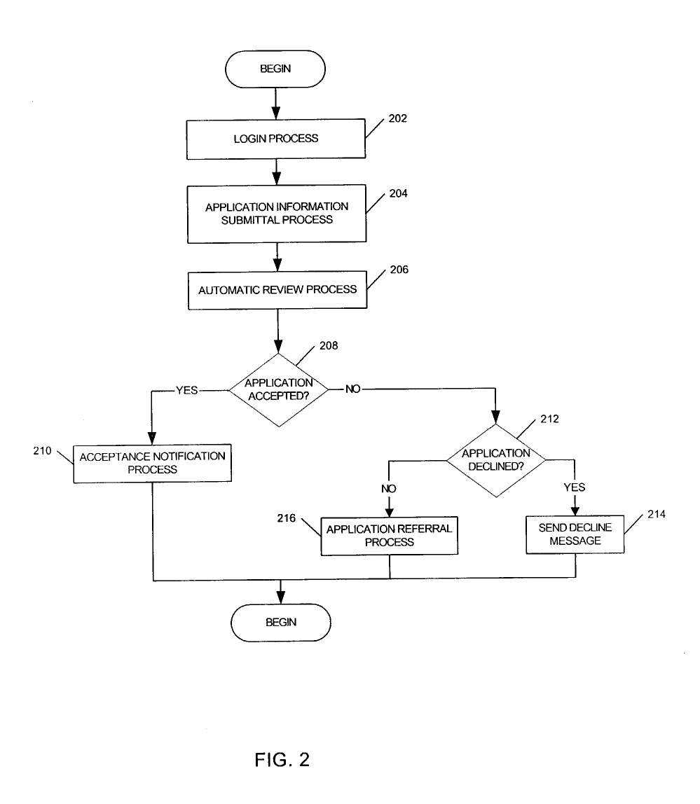

FIG. 2 illustrates a flowchart of a method for submitting and reviewing application information in accordance with an embodiment of the invention. In one embodiment, a Requester (also referred to herein as a “user”) interacts with the system at a client computer (also referred to as a “first computer”), at which the Requester logs onto the system, and enters application information for a Customer or Potential Customer. The Requester could be the Customer or Potential Customer, or a representative or Agent of the Customer or Potential Customer.

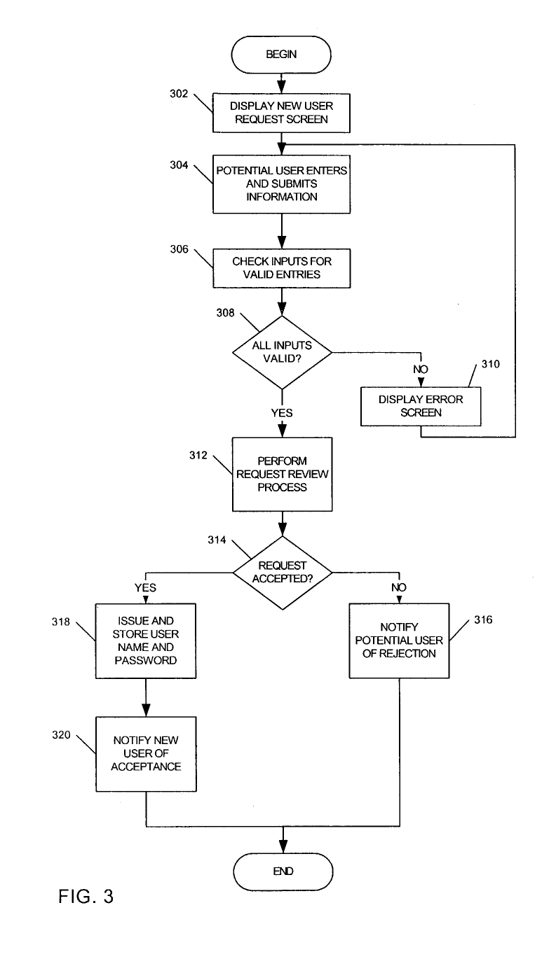

The method begins, in one embodiment, by performing a login process, in block 202. During the login process, the Requester is required to submit login information, such as a valid user name and password. The system then grants or denies the Requester the ability to view, submit, modify or otherwise manipulate data maintained by the system. In order to receive a user name and password, a Requester performs a new user registration process, which will be described in more detail later in conjunction with FIG. 3.

In one embodiment, the system is accessible through a website, onto which a Requester logs in. The website includes multiple, linked pages. As used herein, the term “page” means one or more screens displayed on a computer, or other information that assists a computer in generating or displaying information.

The system is initially accessed, in one embodiment, when the Requester requests a system web page using a browser executed on the client computer. For continuity purposes, the description of the embodiments walks through a particular sequence of pages. It would be obvious to one of skill in the art that the sequence of pages accessed could be different than that described herein.

A Requester could attempt to enter the website at the highest level page (e.g., the home page), or a Requester could attempt to directly access a lower level page using more specific URL information. Either way, the login process is performed. In one embodiment, the Requester initiates the login process by clicking on a login element of a page. In another embodiment, the login process could be automatically initiated by the system (e.g., when a Requester not currently logged in attempts to access a restricted page or information).

In one embodiment, the login process involves the server causing the client to display a login screen. The Requester then enters a user name and password, in one embodiment. If the user name and password are validated by the system, then the system permits the Requester to perform various activities. If not, then the system notifies the Requester that access is denied. The activities that a particular Requester is allowed to perform, and the data that the Requester is allowed to view or manipulate, depends on the level of access that the particular Requester has, in one embodiment.

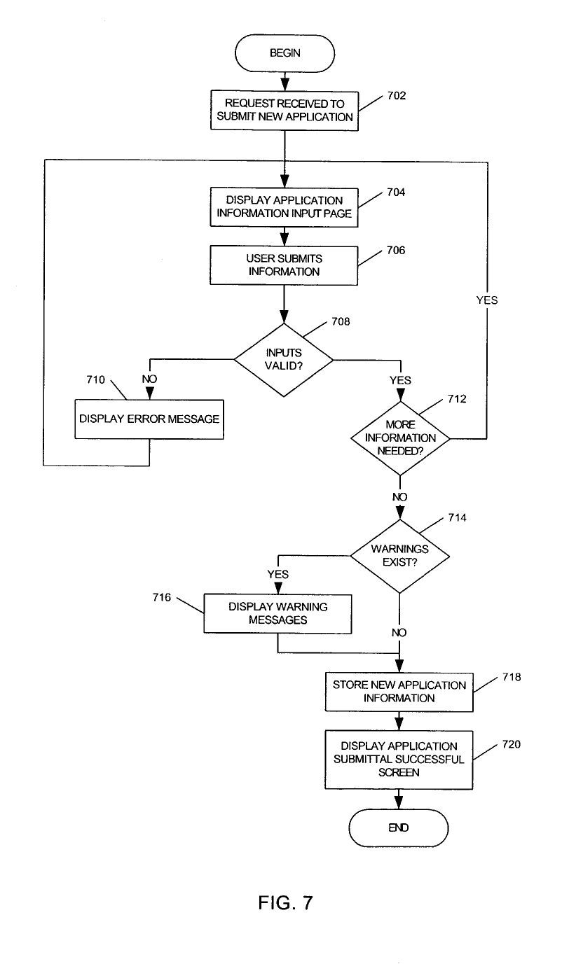

After a Requester has successfully logged in, the Requester can initiate an application information submittal process, which is performed in block 204. The application information submittal process is described briefly here, and in more detail in conjunction with FIG. 7. During this process, the Requester requests and submits application information. To initiate a request, the Requester's computer (e.g., a client computer) requests one or more pages that enable the Requester to enter application information.

After receiving the request, the server sends and causes the client computer to display one or more application information input screens (referred to for convenience as an Application). In various embodiments, the Application could be produced from one or more HTML files and/or scripts run on the server. Alternatively, the Application could be produced by some other electronic means, which enables the user to enter application information, which is sent by the client to the server.

After or while the Requester entering the application information, the client sends the application information to the server. If the submitted information is missing required fields or has erroneous data, then the Requester is so informed, and given an opportunity to correct the defects, in one embodiment.

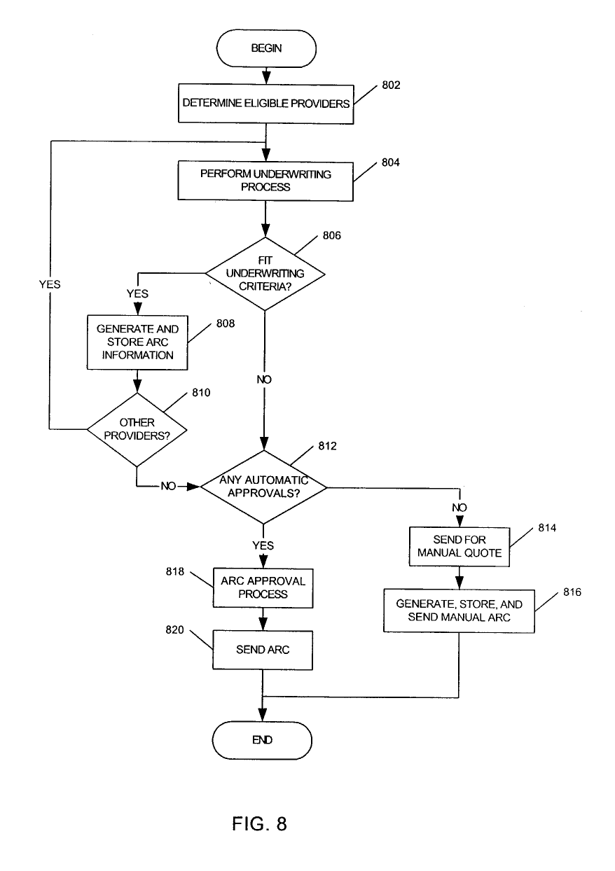

The server or other computer upon which all or a portion of the process is implemented then performs an automatic review process, in block 206. As will be described in more detail in conjunction with FIG. 8, the automatic review process evaluates the submitted application information in light of one or more electronically-stored rule sets. For example, but not by way of limitation, if the Application is an application for insurance, the automatic review process would apply one or more sets of underwriting rules to the submitted information, where a distinct rule set could exist for each of multiple potential Providers and/or for various types of requested insurance. As another example, if the Application is an application for a loan, the automatic review process might perform a credit check and compare the results to a rule set designed to evaluate the credit risk of a Customer or Potential Customer.

In one embodiment, the review process evaluates the submitted application information, and decides whether to: 1) automatically accept the Application; 2) automatically decline the Application; or 3) to initiate additional review before accepting or declining the Application.

A determination is made, in block 208, whether the review process resulted in a decision to automatically accept the Application. If so, then an acceptance notification process is performed, in block 210, and the method ends. In one embodiment, this involves generating and storing information for an ARC. For example, but not by way of limitation, the ARC could be an insurance quote or contract. In one embodiment, which will be described in more detail in conjunction with FIG. 8 (block 818), an intermediate, manual review is performed before sending the Requester the ARC.

If the Application was not automatically accepted, a determination is made, in block 212, whether the review process resulted in a decision to automatically decline the Application. If so, then an Application denial message is sent to the Requester, in block 214, and the method ends. If not, then it can be assumed that the Application needs to be further reviewed before accepting or declining the Application. In this case, an application referral process is performed in block 216, and the method ends. The application referral process is described in more detail in conjunction with FIG. 8 (block 814).

FIG. 3 illustrates a flowchart of a method for authorizing a potential new user (e.g., an Agent, Producer, Customer or Potential Customer) to access the system in accordance with an embodiment of the invention. In one embodiment, a potential new user who is not a registered user can request membership by initiating the process of requesting a login. In one embodiment, a potential new user is able to initiate the process by indicating (e.g., from a login screen or the home page) that the potential new user desires a user name and password. If a potential new user makes such an indication, the client computer sends a request to the server, and the server sends and causes the client to display a new user request screen, in block 302.

The new user request screen includes input fields (e.g., text input fields, radio buttons, check boxes, drop down select lists, etc.) that the potential new user can manipulate to enter user information. In one embodiment, the user information includes personal information (e.g., name, social security number, address, e-mail address, and telephone and fax numbers). In addition, in one embodiment, the user information includes business information. For example, if the potential new user is an insurance agent, the business information can include information describing the company that the agent works for, and the agent's professional credentials (e.g., company name, insurance license number, insurance license state, license expiration date, insurance type, etc.).

After the potential new user has entered and submitted the information (e.g., by selecting a “Submit” or “Next” button), in block 304, then the server or client checks the values submitted in each required input field to make sure that each entry is valid, in block 306. For example, each required input field is checked to make sure an entry was made, and that the entry is of the correct type (e.g., a 9-digit number was entered into the social security number element).

A determination is made, in block 308, whether all entries are valid. If not, then an error page is displayed, in block 310, and the potential new user is given the ability to re-submit the user information. If all entries are valid, then a review process is performed, in block 312, during which the server or a designated individual evaluates the potential new user information to determine whether or not to accept the new user's request to register. This determination could be made based on various criteria. For example, the license number could be checked to make certain that it is a real number, and that the license has not been revoked or suspended.

A determination is made, in block 314, whether or not the request will be accepted, based on the review. If not, then the potential new user is notified, in block 322, and the method ends. In one embodiment, the potential new user is sent an e-mail, indicating that their request to register was declined. In another embodiment, the server causes the client computer to display a message with the same indication.

If the request is accepted, then a user name and password are issued and stored, in block 318. In one embodiment, the new user is then notified, in block 320, and the method ends. In one embodiment, the new user is sent an e-mail, indicating that their request to register was accepted, and including the user name and password. In another embodiment, the server causes the client computer to display a message with the same indication. After a new user has been successfully registered, the new user can log into and use various features of the system.

In one embodiment, a system home page is the first web page that a registered user will encounter when they log into the system. The system home page can include information catered to the registered user, such as a summary of the status of applications awaiting approval, for example. In one embodiment, the system home page enables a registered user to access functions of the system. The functions available to a registered user are limited, in one embodiment, by permissions set by a system administrator.

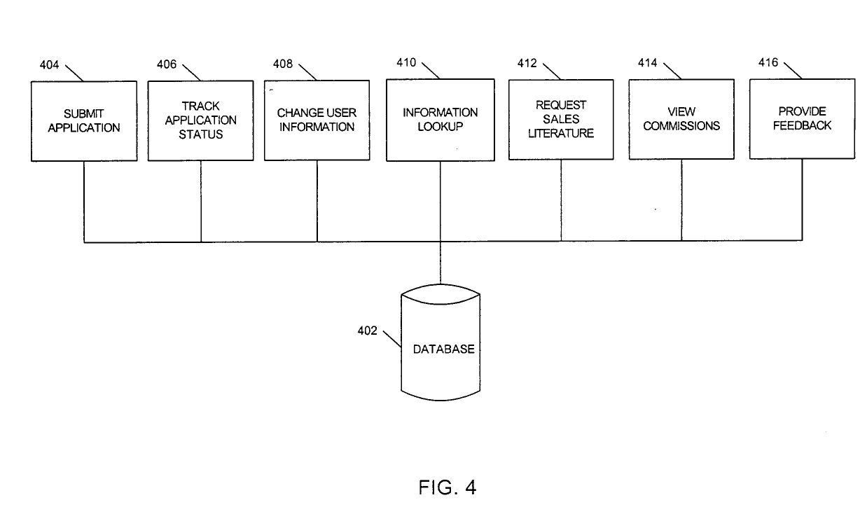

FIG. 4 illustrates a block diagram of example features available to a registered user in accordance with an embodiment of the invention. In one embodiment, each of these features can be selected by a registered user from the system home page, or from one or more of the other pages associated with the website. Alternatively, a user could enter a URL into the browser, which will directly request a page associated with a feature. A user may be asked to log in before being given the ability to user some or all of these features.

In one embodiment, the features are implemented by executing scripts by an application server (e.g., application server 110, FIG. 1). The client merely requests information and displays received information in the format specified by the server. In another embodiment, the client could have special application software, which enables the client to execute code that implements some of the features.

Some or all of these features may access information stored within a database 402. In one embodiment, a client requests information within the database through a server.

In one embodiment, features available to some or all registered users include the ability to submit a new application 404, track application status 406, change user information 408, look up various types of information 410, request sales literature 412, view commission information 414, and provide feedback to system administrators 416. In other embodiments, more, fewer or different features could be available to a registered user. Each of these features is described in detail, below, in conjunction with other Figures.

Besides features available to registered users, other features are available to “administration-level” users, in one embodiment. In general, an administration-level user has a higher level of system access than other registered users. An administration-level user could be an individual associated with the business entity that provides the service, or an individual associated with an Agent, Broker, Customer or Potential Customer. In one embodiment, the system enables an administration-level user to access additional features of the system from the system home page. As with a registered user, the functions available to a particular administration-level user can be limited by permissions set by a system administrator.

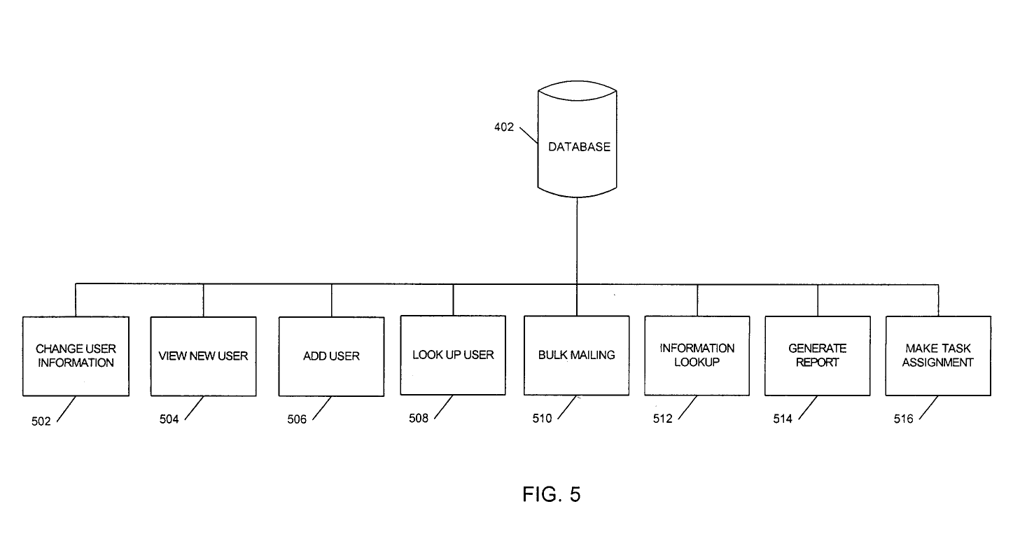

FIG. 5 illustrates a block diagram of example features available to an administration-level user in accordance with an embodiment of the invention. In one embodiment, each of these features can be selected by an administration-level user from the system home page, or from one or more of the other pages associated with the website. Alternatively, an administration-level user could enter a URL into the browser, which will directly request a page associated with a feature. As with other registered users, an administration-level user may be asked to log in before being given the ability to user some or all of these features. As with the registered user features described in conjunction with FIG. 4, in one embodiment, the administration-level features could be implemented by executing scripts by an application server, or the client could have special application software.

Some or all of these features may access information stored within the database 402. In one embodiment, a client requests information within the database through interactions with a server.

In one embodiment, features available to some or all administration-level users include the ability to change user information 502, view new user information 504, add new users 506, lookup user information 508, perform bulk mailing operations 510, look up other information 512, generate reports 514, and assign tasks 516. In other embodiments, more, fewer or different features could be available to an administration-level user. Each of these features is described in detail, below, in conjunction with other Figures.

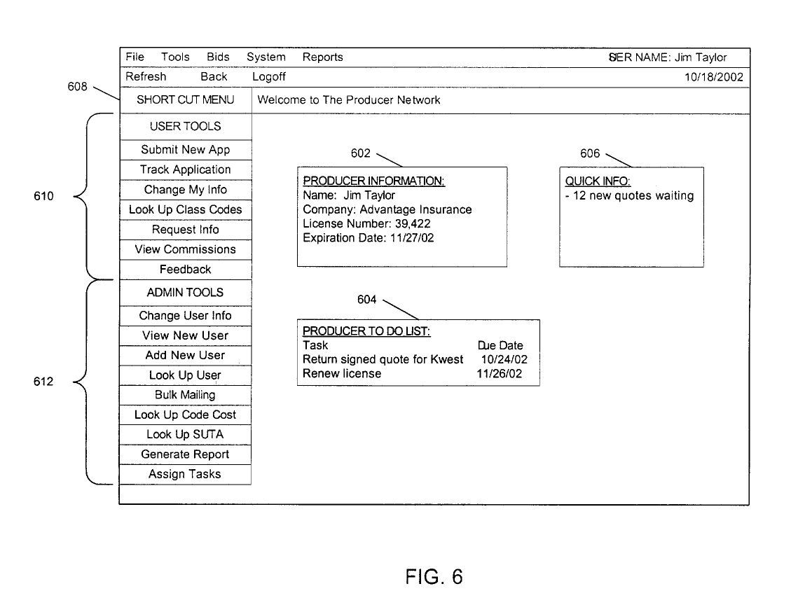

FIG. 6 illustrates an example of a system home page computer screen enabling a registered user and/or an administration-level user to select a feature of the system in accordance with an embodiment of the invention. In the given example, the registered user is a Producer (e.g., an insurance agent or broker).

In one embodiment, the home page includes a field 602 with the registered user information (i.e., “Producer Info:”), a field 604 with a “To Do List,” which includes electronic reminders of items that the user should complete in order to keep various application processes in motion, and a field 606 with “Quick Info” (e.g., the number of new quotes available for the user to view). More, fewer, or different fields could exist in other embodiments.

In addition, in one embodiment, the home page includes a “Short Cut Menu” 608, which includes a list of available features. In one embodiment, the menu includes “Producer Tools” 610, which are features available to all registered users, unless their permissions preclude them from using certain features. These include the features listed in conjunction with FIG. 4, in one embodiment. In addition, in one embodiment, the menu includes “Admin Tools” 612, which are features available to administration-level users, unless their permissions preclude them from using certain features. These include the features listed in conjunction with FIG. 5, in one embodiment. In another embodiment, if a registered user is not an administration-level user, then the Admin Tools 612 list of options is not displayed on the home page. More, fewer or different features could be available to registered users and administration-level users, in other embodiments.

The features available to registered users and administration-level users are described in detail, below, in conjunction with the remaining Figures. In general, the description of the features follows the sequence in the list of features illustrated in the Short Cut Menu 608. Accordingly, the first feature described is the ability to submit a new application.

FIG. 7 illustrates a flowchart of a method for submitting a new application in accordance with an embodiment of the invention. The process corresponds to the application information submittal process 204, FIG. 2.

The new application submission process is used by Potential Customers, or by Agents to submit a Potential Customer's information to the system in order to request a quote or other correspondence for a Product. For purposes of description, the new application submission process is described in the context of an Agent (or Producer or Broker) submitting application information for a corporate Potential Customer to obtain one or more quotes for Workers' Compensation insurance. In other embodiments, the process could be modified to enable a representative (e.g., an employee) of the Potential Customer to input the information himself or herself. Alternatively, the application could be for an individual. In addition, the application could be an application for another type of insurance coverage, for another business service, or for other Products (e.g., utilities, loans, etc.). Modifications to the process to account for these alternative types of applications would be obvious to one of skill in the art based on the description.

The method begins, in block 702, when a registered user indicates (e.g., by clicking the “Submit Application” menu item), that the user wants to submit a new application. In one embodiment, the client requests an application information input page from the server, and the server causes a first application information input page to be displayed on the client computer, in block 704.

In one embodiment, the first application information input page includes fields that prompt the user for various information pertaining to the Potential Customer. For example, this information could include: Customer name; tax ID; address; years in business; and company contact information. Other or different information also could be included. Various page elements could assist the user in entering the information. For example, this and other information input pages could include text input fields, drop down menus (e.g., state lists, business type lists, etc.), links to various tables of information (e.g., class code tables, SUTA rate tables, etc.), and other types of elements.

In block 706, the user submits the information in the first application information input page (e.g., by clicking a “Submit” or “Next” page element). The server then makes a determination whether all submitted inputs are valid, in block 708. For example, the server could check the database to see whether a bid (e.g., a quote) already exists for the Potential Customer. In addition, the server could check portions of the submitted information to make sure the information is valid (e.g., the server could search to determine whether the tax ID matches the customer name). If the information is not valid, then the server causes the client computer to display an error message. The user is then given the opportunity to correct the information, in one embodiment.

If all inputs are valid, then a determination is made, in block 710, whether more information is needed. If more information is needed, then another application information input page is displayed, in block 704, and the procedure iterates as shown. The contents of the next application information input page may or may not be based on the previously submitted information. For example, in one embodiment, when a user is applying for Workers' Compensation insurance on behalf of a Potential Customer, a second application information input page is displayed.

The second application information input page prompts the user to enter information relating to the desired coverage. For example, since Workers' Compensation coverage differs from state to state, a user could enter information into a Workers' Compensation class code table, with one or more rows of information for each state in which coverage is desired. In each row, the user could enter: the state, the class code for the type of insurance; the category of Workers' Compensation (e.g., gas or lease operator, domestic workers inside, etc.); the number of employees to be covered under the class code; the approximate annual payroll associated with the class code; and the rate. In addition, the user could be prompted to enter additional information. For example, for each state, the user could enter the EMod, discount, credit, and SUTA rate information. In an alternate embodiment, the system could auto-fill some of these fields, by looking up the various information for each state in one or more tables (e.g., class code and/or SUTA rate tables) available to the server and/or stored in the database.

The user could also be prompted for other information, such as: a description of the Potential Customer's business; the names of other insurance companies with which the Potential Customer currently holds one or more policies; the renewal or expiration date of those policies; current premiums paid; prior loss information; and prior claim information. In other embodiments, the system could prompt the user for more, less or different information. In particular, if the user is applying for a different type of insurance product, or a different business product (e.g., payroll services, human resources services, etc.), then the information would be substantially different, as would be obvious to one of skill in the art based on the description herein.

Again, a determination is made whether all inputs are valid, in block 708, and whether more information is needed, in block 710. For example, when a user is applying for insurance coverage for a Potential Customer, another application information input page could prompt the user for information such as: whether the Potential Customer is with another P.E.O.; whether the Potential Customer currently offers benefits; whether the Potential Customer requires certified payroll; whether the Potential Customer has always carried Workers' Compensation coverage without lapse; whether the Potential Customer has ever had Workers' Compensation coverage non-renewed or cancelled by a prior carrier; whether the Potential Customer operates as an employee leasing form or temporary labor agency; whether the Potential Customer ever discontinued any operations; whether the Potential Customer uses volunteer labor; whether the Potential Customer has operations in more than one state; what type of business the Potential Customer is (e.g., sole proprietorship, S. Corp., C. Corp., LLC, LLP, Not for profit, etc.); and when the Potential Customer's payroll is run (e.g., bi-weekly, monthly, etc.). The above list of questions is for example purposes, and is not meant to limit the scope of the invention. More, fewer or different questions could alternatively be asked.

In one embodiment, if the Potential Customer currently offers benefits, then an additional application information input page is displayed, which prompts the user for additional benefits information. For example, this additional information could include questions regarding: what type of benefits the Potential Customer offers (e.g., medical, dental, life, vision, etc.); values for benefits currently offered; whether claims to a heart condition, cancer, immune system disorder, or other malady had been submitted within certain numbers of years; and whether any claims exceeded a defined threshold (e.g., $5,000).

The description, above, obtains information from the user by sequentially providing three application information input pages. In an alternate embodiment, a user may be able to submit all application information on a single page. In other alternate embodiments, the user may be able to submit information on more or fewer pages. For example, in one embodiment, the server could cause pages to be sequentially displayed for each application question or set of questions.

Once all information regarding an application has been submitted and validated, then the submitted information is evaluated to determine, in block 714, whether any warnings exist, in one embodiment. If one or more warnings exist, then the server causes the client computer to display one or more warning messages, in block 716. For example, the user could be warned that information must be presented in a certain way in order for the system to evaluate the application for multiple potential Providers (e.g., loss data must be separated for medical and indemnity claims). As another example, the user could be warned that, for some potential Providers, submitted loss information must be verifiable by hard copy loss runs from a previous insurance carrier.

The application information is then stored, in block 718. In one embodiment, the information is stored in a database (e.g., database 108, FIG. 1), accessible to the system. The information can also be incorporated into a form, in one embodiment, which includes the Agent information, the Potential Customer information, and other information. The form is also or alternatively stored, in other embodiments. The server then causes the client computer to display an “Application Submittal Successful” screen, in block 720, and the process ends.

Referring back to FIG. 2, after the application information submittal process 204 is completed (e.g., in accordance with the embodiment described in conjunction with FIG. 7), then an automatic review process 206 is performed.

FIG. 8 illustrates a flowchart of a method for performing automatic application review (e.g., underwriting) in accordance with an embodiment of the invention. In one embodiment, the process automatically occurs once a user has completed the application submission process.

The process begins, in block 802, by determining eligible potential Providers. For example, if the application is for Workers' Compensation insurance, then only Providers who could provide Workers' Compensation insurance would be eligible. In addition, if the user was unable to provide some information that is required by a potential Provider, then that potential Provider could be excluded from consideration. Also, a user could have identified one or more potential Providers whom the user only wanted to consider. Various other criteria could alternatively be used to include or exclude a potential Provider from consideration.

In block 804, an underwriting process is performed for an eligible Provider. In one embodiment, this involves applying an underwriting rule set specific for that Provider and the requested type of Product to the submitted application information. A determination is made, in block 806, whether the application information fits the underwriting criteria. For example, if the underwriting criteria specifies a maximum previous loss history, and the application information indicates that the Potential Customer's losses were greater than the maximum, then a determination would be made that the application information does not fit the underwriting criteria. The types of underwriting criteria that a potential Provider might have vary widely from Provider to Provider. Accordingly, those criteria are not discussed in detail here.

If the application information does fit the underwriting criteria for a potential Provider, then an Application Review Communication (ARC) is automatically generated and stored, in block 808, for that potential Provider. In one embodiment, the ARC is a quote, which indicates the terms (e.g., premium, price, duration, conditions, etc.) under which the Product would be offered. In another embodiment, various information for the ARC is generated and stored, but the ARC itself is generated later.

If the application information does not fit the underwriting criteria, as determined in block 806, or after generation of the ARC information in block 808, then a determination is made whether any other eligible Providers exist, in block 810. If so, then the process iterates as shown, applying a new underwriting rule set, until an automatic underwriting process has been performed for each eligible potential Provider.

If underwriting has been performed for all eligible Providers, then a determination is made whether any automatic approvals occurred during the underwriting process, in block 812. If not, then an electronic notification (e.g., an e-mail) is generated and sent to a designated individual to perform a manual quoting process for the Potential Client, in block 814. If the manual quoting process is successful, and a Product will be offered to the Potential Customer, then in block 816 the individual can create and store an ARC, cause the ARC to be sent to the user, and the method ends.

If one or more automatic approvals did occur during the automatic underwriting process, then in block 818, in one embodiment, an electronic notification (e.g., an e-mail) is generated and sent to a designated individual to request that they approve the information in each automatically generated ARC. The e-mail includes the ARC, information contained within the ARC, or an indication of a location of the ARC or the information. As an example, if three quotes resulted from the automatic underwriting process, the designated individual would be asked to review each of the three quotes. The individual could edit the information, if desired.

If approved, the designated individual could then cause any or all of the ARCs to be sent to the user, in block 820. In another embodiment, no manual approval process is performed in block 818, and the ARCs are sent directly to the user, or the user is otherwise notified of their existence. In one embodiment, the ARCs are sent in the form of an e-mail or e-mail attachment. In another embodiment, the user could be informed that one or more ARCs exist, and are available to the user. The method then ends.

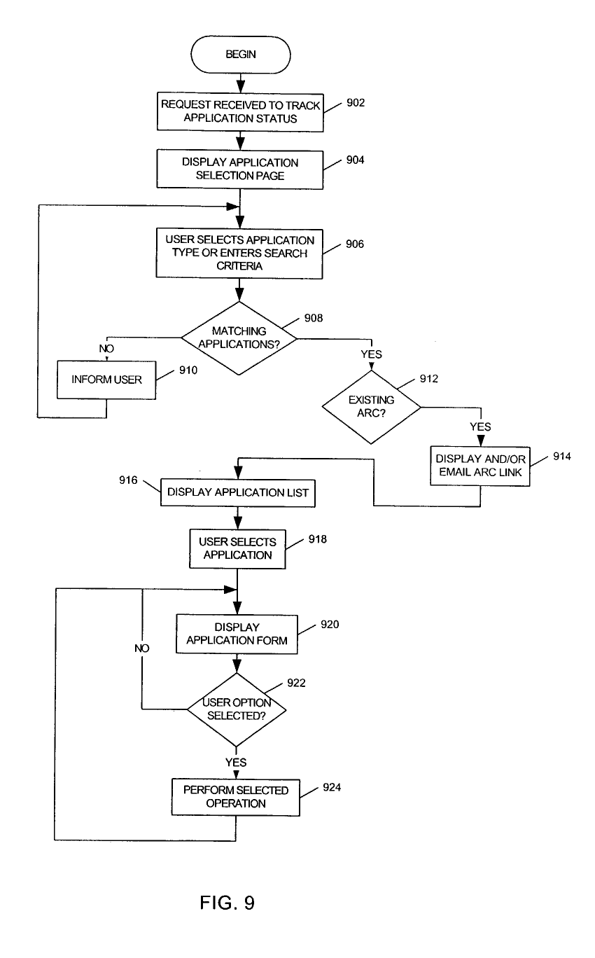

Referring back to FIG. 6, another feature available to a registered user under the Short Cut Menu 608 is the ability to track the status of an application (or bid). FIG. 9 illustrates a flowchart of a method for tracking the status of an application in accordance with an embodiment of the invention.

Once an application has been submitted, the status of that application can be tracked by a user with appropriate permissions, in one embodiment. The tracking process enables a user with appropriate permissions to change application inputs, submit applications for the quote process, and perform several other functions, in various embodiments, as will be described below. In addition, the tracking process enables various corresponding parties (e.g., potential Providers, underwriters, Customers, Potential Customers, etc.) to access submitted applications.

The method begins, in block 902, when a registered user indicates (e.g., by clicking the “Track Application” menu item), that the user wants to track the status of a previously submitted application. In one embodiment, the client requests an application type selection page from the server, and the server causes the application selection page to be displayed on the client computer, in block 904.

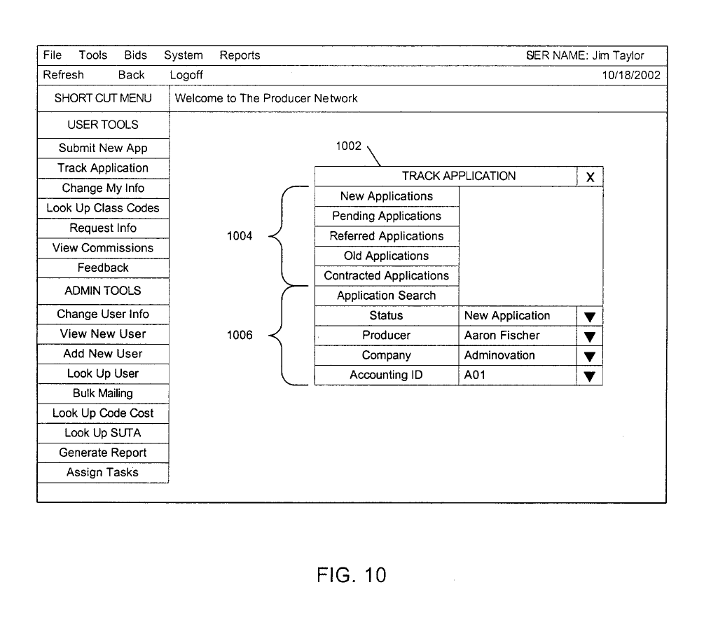

FIG. 10 illustrates an example of a computer screen that displays an application type selection page 1002 in accordance with an embodiment of the invention. The application type selection page 1002 includes a list of selectable application types 1004, in one embodiment, which enables a user to indicate the types of applications that the user is interested in tracking. In the example shown, a user can indicate that he or she would like to see a list of new applications, pending applications, referred applications, old applications, or contracted applications. More, fewer or different application types could be included, in other embodiments.

In addition, in one embodiment, the application selection page 1002 includes a search criteria area 1006, into which a user can enter information to limit a search for applications that have certain characteristics. For example, a user can have the opportunity to enter a status type, Producer name, company name, and accounting ID (e.g., an internal accounting system ID that facilitates joining quoted data to an actual payroll or other process). More, fewer or other search criteria could be included, in other embodiments. In one embodiment, once the search criteria are entered, the user can select “Application Search,” and the system will initiate the search.

Referring back to FIG. 9, a user selects an application type or enters search criteria into the application selection page, in block 906. A determination is then made, in block 908, whether any applications match the selected type or criteria. If not, then the user is informed that no such applications exist, in block 910, and the procedure iterates as shown, giving the user an opportunity to re-configure the search.

If one or more applications do match the selected type or criteria, then in block 912, a determination is made whether an ARC exists for one or more of the matching applications. For example, if an application is an insurance application, an ARC could be a quote or a contract based off of the application. If an ARC exists for one or more of the matching applications, then in one embodiment, a link to each ARC is displayed on the client computer, and/or a link to each ARC is e-mailed to the user, in block 914.

Whether or not an ARC exists, a list of the matching applications is displayed on the client, in block 916, in one embodiment. In one embodiment, the matching applications can be sorted by company name, status, date, gross pay, number of employees, and/or other factors.

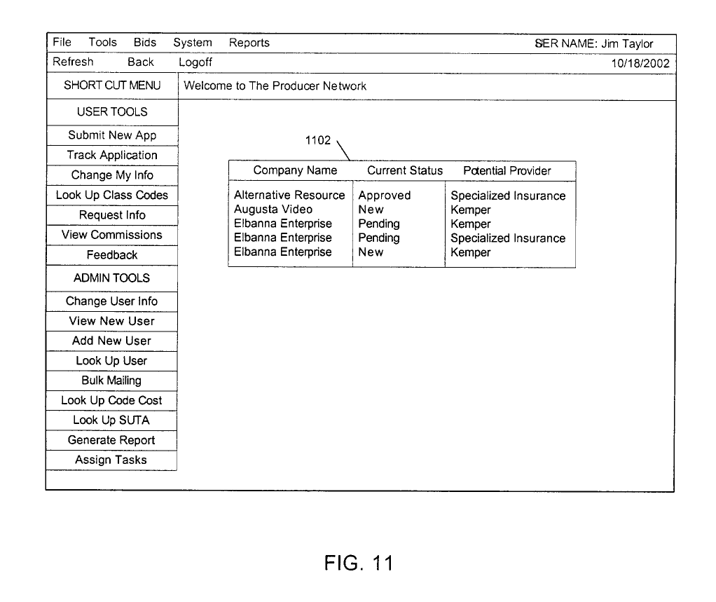

FIG. 11 illustrates an example of a computer screen that displays an application list 1102 in accordance with an embodiment of the invention. For each application in the list 1102, information is displayed identifying the company name of the Customer or Potential Customer, the current status of the application, and one or more potential Providers. In alternate embodiments, more, fewer or different information could be displayed.

Referring also to FIG. 9, a user can select an application from the list 1102, in block 918. For example, the user can click on one of the applications listed. Once an application is selected, the server causes the client to display an application form, in block 920, corresponding to the selected application.

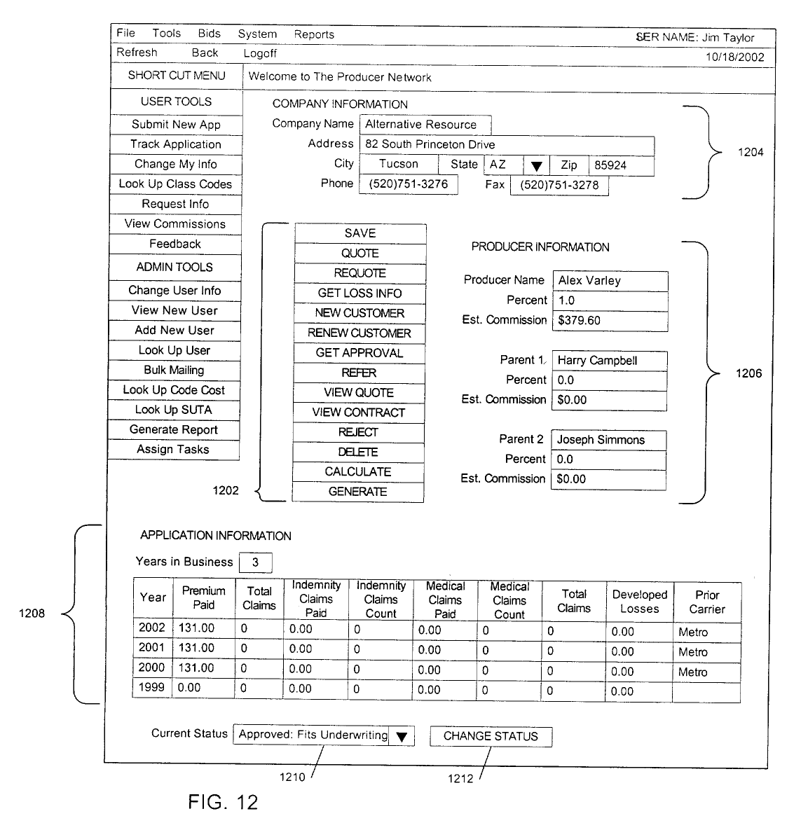

FIG. 12 illustrates an example of a computer screen that displays an application form in accordance with an embodiment of the invention. In one embodiment, the screen includes a selectable list 1202 of user options, a set of editable fields that includes company information 1204, a set of editable fields that includes Producer information 1206, a set of editable fields that includes application information 1208, and an application status field 1210. The information displayed in each of fields 1204, 1206, 1208, and 1210 are for example purposes only. Additional or different information also could be displayed. For example, besides the premium and years in business information illustrated in the application information field 1208, information such as prior and current policy information, class codes, rate comparison information, profit information, and other information also could be displayed.

Referring again to FIG. 8, a determination is made whether a user option (e.g., from list 1202, FIG. 12) has been selected, in block 922. If not, the procedure iterates as shown, waiting for user input. If so, then the selected operation is performed, in block 924, and the procedure iterates as shown.

Referring back to FIG. 12, each of the selectable options in list 1202 will be briefly described below. In one embodiment, the user is given the ability to choose from one or more of the following options: save edits to the application form; initiate a quoting process; requote a previously quoted application; get loss information; perform a new client procedure; perform a client renewal procedure; get a manual approval of an application or ARC; refer an application; view a quote; view a contract; reject the application; delete the application; perform some calculations; or generate an ARC. Other options also could be provided to the user. For example, when the application pertains to Workers' Compensation insurance, the user could be given the opportunity to select an option that will determine evidence of Workers' Compensation insurance, or to create a Workers' Compensation certificate. In other embodiments, more, fewer or different user options could be provided.

If a user modifies any entries within the editable fields 1204, 1206, 1208 and selects the “Save” option, then the application information in the database will be updated. In one embodiment, any previously submitted application information could be modified. For example, a user could add or delete a Workers' Compensation code, or edit any other application information. Similarly, if the user selects the “Delete” option, the application information in the database will be removed.

If the user selects the “Quote” or “Requote” options, then the application will be forced into a manual quoting process. In one embodiment, this process is initiated when the server sends the application information (or a link to the application information) to a designated individual. For example, this information could be sent in an e-mail or other type of electronic correspondence.

If the user selects the “Get Loss Info,” “Get Approval” or “Refer” options, then the appropriate application information will be included in an electronic correspondence (e.g., an e-mail), which is automatically sent to one or more designated individuals for their review. In one embodiment, the e-mail could be pre-screened by the user before the e-mail is sent out to the one or more designated individuals. In the case of the “Get Loss Info” option, the e-mail requests that a designated individual obtain hard copy loss information to be evaluated during the underwriting process. In the case of the “Get Approval” option, the e-mail requests that the designated individual review the application information and manually approve or decline the application. In the case of the “Refer” option, the e-mail requests that an individual associated with a Provider evaluates the application information to make an approval or decline decision.

In one embodiment, if the designated individual does not return the loss information or manually approve or decline the application, as requested, within a certain period of time, then the application is automatically rejected. For example, the period of time within which the requested action should be completed could be 30 days. More or less time could be designated, as well.

If the user selects the “New Customer” option, then the user will be given the ability to enter application information for a new Potential Customer. If the user selects the “Renew Customer” option, then previously entered application information for an existing Customer is imported as the application information for a new application. In one embodiment, a “New Customer Kit” is generated for submittal to the Customer or Potential Customer.

If the user selects the “View Quote” or “View Contract” options, then the quote or contract information is retrieved from the database, and the server causes the client to display the quote or contract.

If the user selects the “Reject” option, then the server causes the client to prompt the user to enter a reason for the rejection. The rejection information is stored in the database, and the status of the application is changed to “Rejected.”

If the user selects the “Calculate” option, then a process of automatic application review is performed. In one embodiment, this process is substantially the same as the process described in conjunction with FIG. 8.

A user can also select an “Update Status” option 1212, which enables the user to change the current status of an application. For example, if an application is in a manual review process, and the underwriter determined to reject the application, the user could change the status from “Pending” to “Rejected.”

The description, above, illustrates just some of the possible options that could be available to a user of the system of the various embodiments. In other embodiments, more, fewer or different options could be provided to a user within the application tracking process.

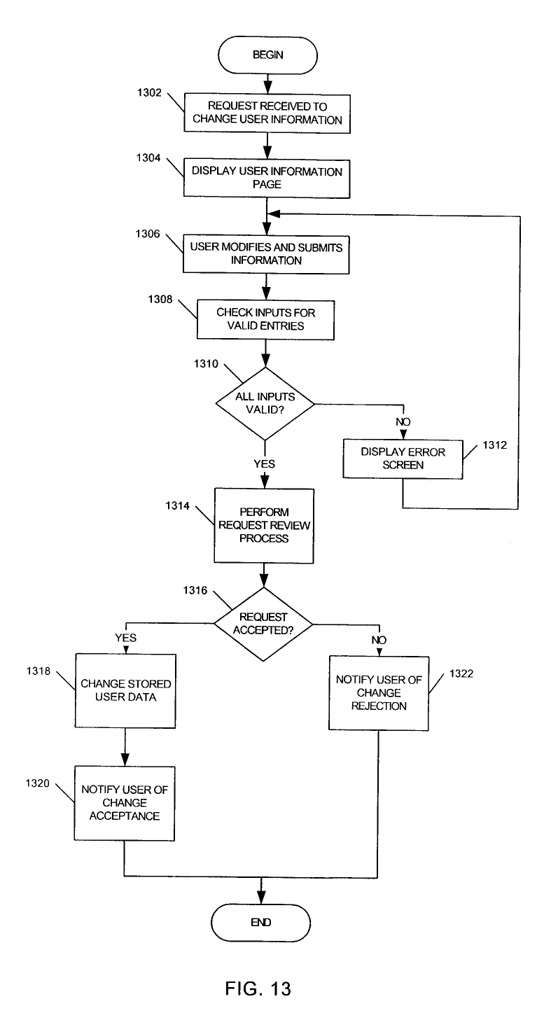

Referring back to FIG. 6, another feature available to a registered user under the Short Cut Menu 608 is the ability to change the user's information that is stored with the system. FIG. 13 illustrates a flowchart of a method for changing user information in accordance with an embodiment of the invention.

The method begins, in block 1302, when a registered user indicates (e.g., by clicking the “Change My Info” menu item), that the user wants to change the user's information that is stored in the system database. In one embodiment, the client requests a user information page from the server, and the server causes the user information page to be displayed on the client computer, in block 1304.

In one embodiment, the user information page includes editable fields for the user's personal information. For example, fields could be included for the user's name, social security number, address, phone number, and fax number. In addition, if the user is employed by or represents a company, the user information page includes company information. For example, if the user is an agent associated with an insurance company, the company information could include the company name, the user's insurance license number, insurance license state, expiration date of license, and insurance type. In alternate embodiments, more, fewer or different information fields could be included on a user information page.

After the user has modified and submitted the information (e.g., by selecting a “Submit” or “Next” button), in block 1306, then the server or client checks the values submitted in each required input field to make sure that each entry is valid, in block 1308. For example, each required input field is checked to make sure that it includes an entry, and that the entry is of the correct type (e.g., a 9-digit number is in the social security number element).

A determination is made, in block 1310, whether all entries are valid. If not, then an error screen is displayed, in block 1312, and the user is given the ability to re-submit the user information. If all entries are valid, then a review process is performed, in block 1314, during which the server or a designated individual evaluates the modified user information to determine whether or not to accept the new user's request to change the user information.

A determination is made, in block 1316, whether or not the request will be accepted, based on the review. If not, then the user is notified, in block 1322, and the method ends. In one embodiment, the user is sent an e-mail, indicating that their request to change their user information was rejected. In another embodiment, the server causes the client computer to display a message with the same indication.

If the request is accepted, then the user information is modified in the database, in block 1318. In one embodiment, the user is then notified, in block 1320, and the method ends. In one embodiment, the user is sent an e-mail, indicating that their request to change their user information was accepted. In another embodiment, the server causes the client computer to display a message with the same indication.

Referring back to FIG. 6, another feature available to a registered user under the Short Cut Menu 608 is the ability to look up various information. For example, in an embodiment for insurance users, a registered user can look up insurance class codes or other information. An administration-level user can look up code costs and SUTA rate information. In alternate embodiments, more or different information could be accessed by either a registered user or an administration-level user.

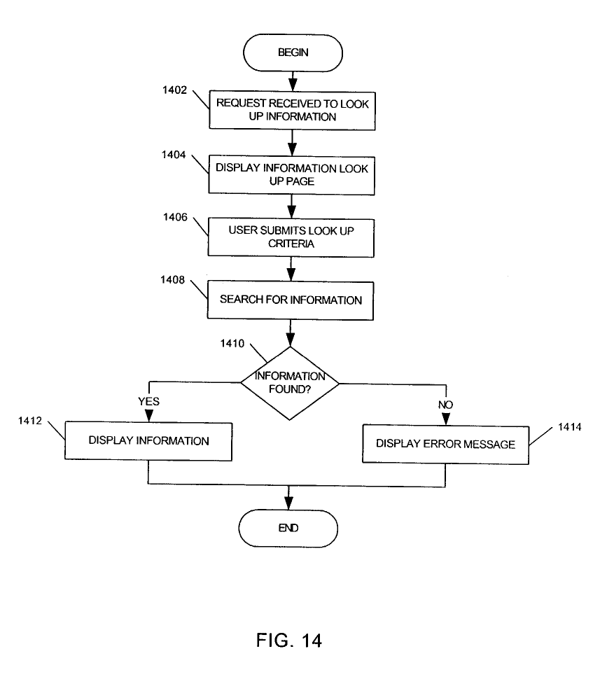

FIG. 14 illustrates a flowchart of a method for looking up information in accordance with an embodiment of the invention. The method begins, in block 1402, when a registered user indicates (e.g., by clicking one of the “Look Up Class Codes,” “Look Up Code Cost” or “Look Up SUTA” menu items), that the user wants to view information that is stored in the system database. In one embodiment, the client requests an information look up page (i.e., a search page) from the server, and the server causes the information look up page to be displayed on the client computer, in block 1404.

The user then submits look up criteria, in block 1406, which identifies the desired information. In one embodiment, the user accomplishes this by entering information into or selecting an option from one or more modifiable page elements. For example, if the user wants to look up a Workers' Compensation class code description or code number, the user enters the code number to look up and/or a description of the Workers' Compensation class code. As another example, if an administration-level user wants to look up Workers' Compensation class codes and/or costs, the user could enter the same information, and could select the state of interest. As even another example, if an administration-level user wants to look up the SUTA rate for a particular state, the user could enter or select the state of interest.

Based on the submitted criteria, then in block 1408, the server performs a search of appropriate tables of information stored in the database. For example, the server could search a Workers' Compensation class code and description table, a SUTA rate table, or other stored information. A determination is made, in block 1410, whether information was found that matched the submitted look up criteria. If so, then the server causes the client to display the requested information, in block 1412. If not, then the server causes the client to display an error message, in block 1414. The method then ends.

Although the description of FIG. 14 uses examples of looking up insurance related information, the method could be used to look up other types of information, as well.

Referring back to FIG. 6, another feature available to a registered user under the Short Cut Menu 608 is the ability to view commission information for the user. In one embodiment, where the user is an Agent (e.g., an insurance agent), the user could earn commissions based on the amount of premiums collected from Customers represented by the Agent. When a user is interested in viewing earned commissions, the user could select this option.

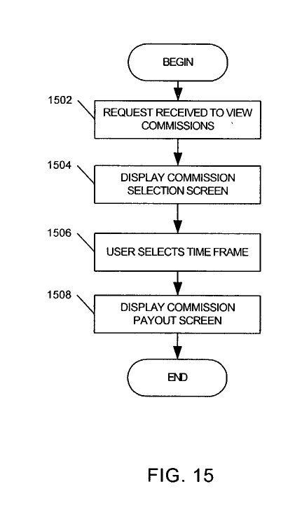

FIG. 15 illustrates a flowchart of a method for viewing commission information in accordance with an embodiment of the invention. The method begins, in block 1502, when a registered user indicates (e.g., by clicking the “View Commissions” menu item), that the user wants to view commission information that is stored in the system database. In one embodiment, the client requests a commission selection page from the server, and the server causes the commission selection page to be displayed on the client computer, in block 1504.

The commission selection page includes one or more elements that enable the user to specify the time frame in which commissions have been earned. For example, in one embodiment, the user could select a particular month. Alternatively, the user could select a larger or smaller range of time. The commission selection page also could include a field with any notes relating to commissions, which the user should be aware of. For example, a note might indicate when commission checks are sent out.

After the user selects a time frame within which the user wants to see commission information, in block 1506, the server causes the client to display a commission payout screen, in block 1508. In one embodiment, the commission payout screen displays a dollar amount of earned commissions for the user for the selected time frame. In an alternate embodiment, a commission payout screen could automatically be displayed when the request to view commissions is received, rather than querying the user for a time frame. After displaying the commission payout screen, the method ends.

In one embodiment, an administration-level user is able to access all of the user tools 610 (FIG. 6) listed under the Short Cut Menu 608. In addition, an administration-level user is able to access additional tools 612, which are not available to users without administration privileges.

Referring back to FIG. 6, one feature available to an administration-level user under the Short Cut Menu 608 is the ability to modify the information of a registered user. This ability to modify user information is similar to the ability provided to users without administration privileges. However, in the prior described “Change My Info” process, the user was only able to edit his or her own information. In the “Change User Info” process available to administration-level users, information can be modified for users other than the user requesting the changes.

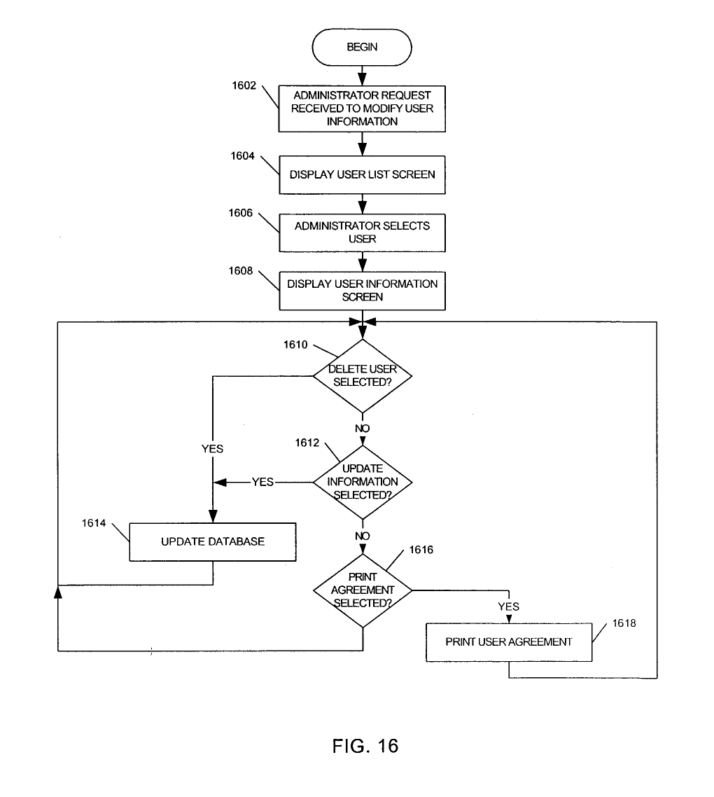

FIG. 16 illustrates a flowchart of a method for an administration-level user to view or change user information in accordance with an embodiment of the invention. The method begins, in block 1602, when an administration-level user indicates (e.g., by clicking one of the “Change User Info” or “View New User” menu items), that the user wants to view or change user information that is stored in the system database.

In one embodiment, when the “Change User Info” option is selected, the client requests a user list page from the server, which includes a list of all registered users for whom the administration-level user has permission to edit their information. Similarly, when the “View New User” option is selected, the client requests new user list page from the server, which includes a list of users who are newly registered with the system. The server causes the user list page or the new user list page to be displayed on the client computer, in block 1604.

From the user list, the administration-level user selects a user, in block 1606, whose information the administration-level user wants to view or edit. In one embodiment, the client requests the corresponding user information page, and the server causes the user information page to be displayed on the client computer, in block 1608.

In one embodiment, along with other options provided along with the user information page, the administration-level user is given the options to delete the selected user's information, update the information, and print a user agreement. A determination is made, in block 1610, whether the administration-level user has selected the delete option. If so, then the database is updated, in block 1614, by deleting the corresponding user information.

If the option to delete the user has not been selected, a determination is made, in block 1612, whether the administration-level user has selected the update information option. Generally, a user would select this option after having modified one or more fields of user information. If the user has selected the update information option, then the database is updated with the modified information, in block 1614.

If the update information option has not been selected, a determination is made, in block 1616, whether the administration-level user has selected the print agreement option. If so, then the system causes a user agreement to be printed, in block 1618. The user agreement would reflect the original or modified user information, and would indicate the terms under which the user is registered with the system (e.g., commission rates, etc.). In an alternate embodiment, the user agreement could be generated electronically and stored, and/or sent to the user in an e-mail or other electronic communication.

Referring back to FIG. 6, another feature available to an administration-level user under the Short Cut Menu 608 is the ability to add a new user. In one embodiment, as illustrated in FIG. 3, when a potential new user wants to become a registered user, the potential new user submits user information. A review request process (block 312, FIG. 3) is then performed. In one embodiment, this review process is partially automatic and partially manual, and is controlled by an administration-level user. If the administration-level user accepts the potential new user's request, then the administration-level user “adds” the new user to the system.

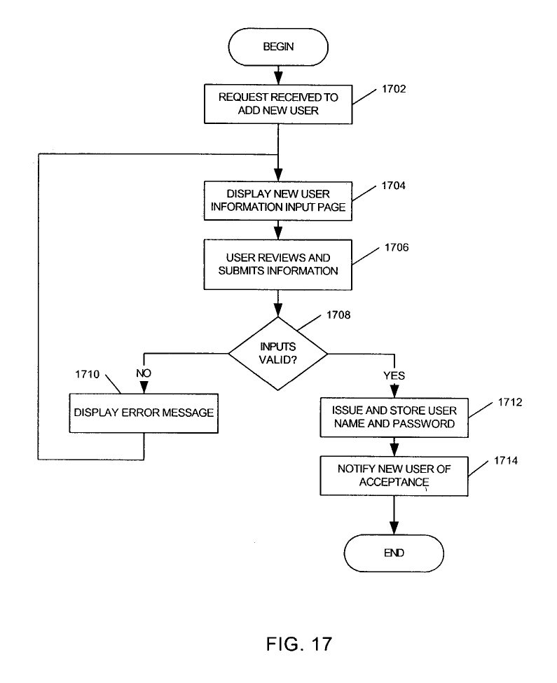

FIG. 17 illustrates a flowchart of a method for adding a new user in accordance with an embodiment of the invention. The method begins, in block 1702, when an administration-level user receives a request (e.g., an e-mail) to add a new user. In one embodiment, this request is automatically generated in response to a potential new user submitting new user information, as was described in conjunction with FIG. 3.

If the administration-level user then selects the “Add New User” option, and identifies the new user, the client computer will request the corresponding user information page for the new user, and the server will cause the client to display the user information page, in block 1704.

The administration-level user then has the ability to review, modify, and submit the information, in block 1706. After the information is submitted, a determination is made whether all inputs are valid, in block 1708. For example, the server determines whether entries exist in all required fields, and whether each entry is in the correct format. If one or more inputs are not valid, then the server causes the client to display an error message, in block 1710, and the administration-level user is given an opportunity to correct the error.

If all inputs are valid, then a user name and password are automatically issued by the system and stored, in block 1712. In one embodiment, a new user can request a particular user name and password during the process of inputting the new user information. The new user is then notified of acceptance, in block 1714, thus indicating that they are now a registered user. In one embodiment, the new user is notified by an email, which includes the user name and password. The method then ends.

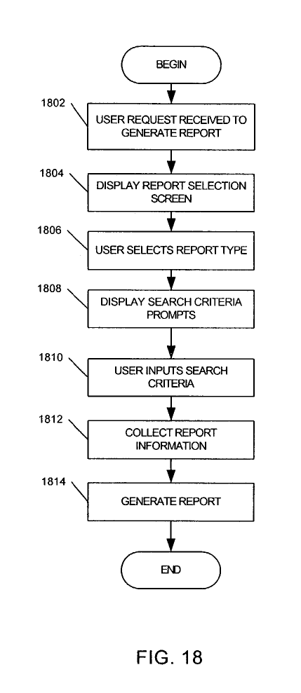

Referring back to FIG. 6, another feature available to an administration-level user under the Short Cut Menu 608 is the ability to generate and view user activity reports. FIG. 18 illustrates a flowchart of a method for viewing reports of user activity in accordance with an embodiment of the invention.

The method begins, in block 1802, when an administration-level user indicates (e.g., by clicking the “Generate Report” menu item), that the user wants to generate a report from information that is stored in the system database. In one embodiment, the client requests a report selection page from the server, and the server causes the report selection page to be displayed on the client computer, in block 1804.

In one embodiment, the report selection page includes one or more elements that enable the user to specify the type of report the user would like to create. For example, a user might want to generate any of the following or other types of reports: monthly bid report; bid breakdown by Producer, bid breakdown by sales representative; bid breakdown by application status; bid breakdown by a “parent” of multiple Producers; new Producer report; sales representative quote report; Producer contact report; and parent Producer report.

After the user selects the type of report to generate, in block 1806, the server causes the client to display search criteria prompts, in block 1808, which enable the user to specify criteria for the report. For example, a user might be given the ability to specify a date range, and to select one or more sales representatives, registered users (e.g., Producers), and/or parents.

The user inputs the desired search criteria, in block 1810. The server then collects the corresponding report information, in block 1812, from the database. Using the collected information, the server generates a report, in block 1814, and the method ends. In one embodiment, the server causes the client to display the report on the screen. In another embodiment, the server can notify the user of a location of the report, or provide a link to the report. The user can then access and/or print the report.

Referring back to FIG. 6, another feature available to an administration-level user under the Short Cut Menu 608 is the ability to assign tasks. In one embodiment, the assignment feature is used by administration-level users or users with appropriate permissions to assign tasks to internal staff with regard to application submissions. In another embodiment, the feature could be used to assign tasks and due dates to Agents, Producers, and other users, as well.

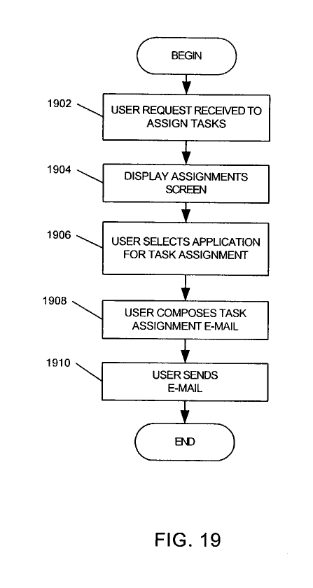

FIG. 19 illustrates a flowchart of a method for assigning tasks in accordance with an embodiment of the invention. The method begins, in block 1902, when an administration-level user indicates (e.g., by clicking the “Assign Tasks” menu item), that the user wants to generate one or more task assignments. In one embodiment, the client requests a task assignment page from the server, and the server causes the task assignment page to be displayed on the client computer, in block 1904.

In one embodiment, the task assignment page includes elements that enable the user to select a particular application for which the user wants to assign a task. After the user has selected an application, in block 1906, a task assignment e-mail shell is automatically generated, in one embodiment. The user then composes the body of the email, in block 1908. In the body, the user is able to specify a task assignment, which pertains to the application. For example, the user might specify that physical documents proving loss information stated on the application must be collected by a certain date.

In block 1910, the user then sends the e-mail to one or more individuals designated to perform the task. The method then ends.

In various embodiments, the method and system of the present invention may include more, fewer or different features from those described above. For example the system could provide an information request function, which a user could access by selecting the “Request Info” menu item. By selecting this function, the server could cause the client to display different types of information available to the user. For example, sales brochures, flyers, presentations, or other information might be available. After the user selects the desired information, the system can display, download, e-mail or provide a link to the desired information.

Another feature that could be available to users, in one embodiment, is a bulk mailing process. For example, a user could access this feature by selecting the “Bulk Mailing” menu item. By selecting this function, the server could cause the client to display an email screen, and enable the user to easily select one or more registered users. After selecting the recipients and composing the e-mail, the user could then send the email to the specified recipients.

Still another feature that could be available is a feedback feature. For example, a user could access this feature by selecting the “Feedback” menu item. By selecting this function, the server could cause the client to display an email with a default address to an individual designated to receive feedback. After composing the e-mail, the user could then send the email to the designated individual.

Conclusion

This application is intended to cover various adaptations or variations of the present invention. The foregoing detailed description is, therefore, not to be taken in a limiting sense, and it will be readily understood by those skilled in the art that various other changes in the details, materials, and arrangements of the parts and steps, which have been described and illustrated in order to explain the nature of this invention, may be made without departing from the scope of the invention as expressed in the adjoining claims. Therefore, all such changes are intended to fall within the scope of the present invention.

What is claimed is:

1. A method comprising:
a first computer sending application information to a second computer, where the application information includes information pertaining to a potential customer of a provider of a product;
the second computer deciding, based on the application information and one or more electronically-stored rule sets, whether or not to generate an application review communication (ARC) for the potential customer, which describes terms under which the product is offered; and
if the second computer decides to generate the ARC, the second computer automatically generating and storing the ARC.

2. The method of claim 1, wherein the product is an insurance product, the one or more electronically-stored rule sets are one or more sets of underwriting criteria, and the ARC is an insurance quote or contract.

3. The method of claim 1, further comprising:
the first computer sending the second computer a request to submit the application information;
the second computer causing the first computer to display a first data input screen, which enables a user of the first computer to enter at least a first portion of the application information.

4. The method of claim 3, further comprising:
the second computer determining whether additional application information is necessary; and
the second computer causing the first computer to display one or more additional data input screens, which enable the user of the first computer to enter one or more additional portions of the application information.

5. The method of claim 1, further comprising:
the second computer further deciding, based on the application information and the one or more electronically-stored rule sets, whether or not to automatically deny the potential customer; and
if the second computer decides to automatically deny the potential customer, the second computer sending a denial message.

6. The method of claim 1, further comprising:
the second computer further deciding, based on the application information and the one or more electronically-stored rule sets, whether or not to enter a manual approval process; and
if the second computer decides to enter a manual approval process, the second computer sending a manual approval message to a designated individual.

7. The method of claim 1, further comprising:
the second computer sending the ARC in an electronic communication.

8. A method comprising:
a second computer causing a first computer to enable a user of the first computer to indicate that the user wants to submit an application to acquire a product;
if the user indicates that the user wants to submit the application, the second computer causing the first computer to display an application information input screen;
the first computer sending application information entered into the application information input screen to the second computer, where the application information includes information pertaining to a potential customer of a provider of the product;
the second computer deciding, based on the application information and one or more electronically-stored rule sets, whether or not to generate an application review communication (ARC) for the potential customer, which describes terms under which the product is offered; and
if the second computer decides to generate the ARC, the second computer automatically generating and storing the ARC.

9. The method of claim 8, wherein the application is an application for insurance coverage, the product is an insurance product, the one or more electronically-stored rule sets are one or more sets of underwriting criteria, and the ARC is an insurance quote or contract.

10. The method of claim 8, further comprising:
the first computer sending a request to the second computer to access an online product application system;
the second computer causing the first computer to display a first login screen which prompts the user of the first computer for login information;
the first computer sending the login information to the second computer, where the login information identifies the user of the first computer; and
the second computer determining whether the login information is valid.

11. The method of claim 8, further comprising:
the second computer causing the first computer to enable the user to indicate that the user wants to track a progress of a previously submitted application;
if the user indicates that the user wants to track the progress, the second computer causing the first computer to display a status of the previously submitted application.

12. The method of claim 11, further comprising:
if the status of the previously submitted application indicates that an ARC exists for the previously submitted application, the second computer causing the first computer to display information enabling the user to access the ARC.

13. The method of claim 12, wherein causing the first computer to display information comprises:
the second computer causing the first computer to display a selectable link identifying the ARC; and
if the user selects the selectable link, the second computer sending and electronic version of the ARC to the first computer.

14. The method of claim 11, further comprising:
if the status of the previously submitted application indicates that a contract exists for the previously submitted application, the second computer causing the first computer to display information enabling the user to access the contract.

15. The method of claim 14, wherein causing the first computer to display information comprises:
the second computer causing the first computer to display a selectable link identifying the contract; and
if the user selects the selectable link, the second computer sending and electronic version of the contract to the first computer.

16. The method of claim 11, further comprising:
if the status of the previously submitted application indicates that the previously submitted application was rejected, the second computer causing the first computer to display information indicating that the previously submitted application was rejected.

17. The method of claim 11, further comprising:
if the status of the previously submitted application indicates that the previously submitted application has been referred for further manual approval, the second computer causing the first computer to display information indicating that the previously submitted application is pending.

18. The method of claim 8, further comprising:
the second computer causing the first computer to enable the user to indicate that the user wants to track a progress of one or more previously submitted applications; and
if the user indicates that the user wants to track the progress, the second computer causing the first computer to display an application type screen, which prompts the user to indicate one or more types of applications that the user wants to track.

19. The method of claim 18, further comprising:
if the user indicates that the user wants to track the progress of a type of application where more than one previously submitted application exists, the second computer causing the second computer to display a list of the one or more previously submitted applications; and
if the user selects a previously submitted application from the list, the second computer causing the first computer to display a status of the previously submitted application.

20. The method of claim 8, further comprising:
the second computer causing the first computer to enable the user to indicate that the user wants to modify a previously submitted application;
if the user indicates that the user wants to modify the previously submitted application, the first computer enabling the user to input modified application information;
the first computer sending the modified application information to the second computer; and
the second computer storing the modified application information.

21. The method of claim 8, further comprising:
the second computer causing the first computer to enable the user to indicate that the user wants to change user information, which includes a user identity and contact information for the user;
if the user indicates that the user wants to change the user information, the first computer enabling the user to input modified user information;
the first computer sending the modified user information to the second computer; and
the second computer storing the modified user information.

22. The method of claim 8, further comprising:
the second computer causing the first computer to enable the user to indicate that the user wants to view other stored information;
if the user indicates that the user wants to view the other stored information, the first computer enabling the user to identify the other stored information that the user wants to view;
the first computer sending a request for the other stored information to the second computer; and
the second computer retrieving the other stored information, and causing the first computer to display the other stored information.

23. The method of claim 22, wherein the other stored information includes insurance codes.

24. The method of claim 22, wherein the other stored information includes insurance descriptions.

25. The method of claim 8, further comprising:
the second computer causing the first computer to enable the user to request sales literature;
if the user indicates that the user wants to receive the sales literature, the first computer sending a request for the sales literature to the second computer; and
the second computer retrieving the sales literature, and sending the sales literature to the first computer.

26. The method of claim 8, further comprising:
the second computer causing the first computer to enable the user to indicate that the user wants to view commission information relating to one or more previously submitted applications;
if the user indicates that the user wants to view the commission information, the first computer sending a request for the commission information to the second computer; and
the second computer retrieving the commission information, and causing the first computer to display the commission information.

27. The method of claim 26, further comprising:
if the user indicates that the user wants to view the commission information, the first computer enabling the user to indicate a date range for the commission information; and
wherein the first computer sending the request for the commission information comprises indicating the date range in the request.

28. A method performed by one or more computers, the method comprising:
maintaining, in electronic form, one or more sets of user information for one or more users of an online product application system, wherein the online product application system enables a first computer to send application information to a second computer, where the application information includes information pertaining to a potential customer of a provider of a product, and the online product application system also causes the second computer to decide, based on the application information and one or more electronically-stored rule sets, whether or not to generate an application review communication (ARC) for the potential customer, which describes terms under which the product is offered, and if the second computer decides to generate the ARC, the online product application system causes the second computer to automatically generate and store the ARC; and
maintaining, in electronic form, the application information, the one or more rule sets, and the ARC.

29. The method of claim 28, wherein the product is an insurance product, the one or more electronically-stored rule sets are one or more sets of underwriting criteria, and the ARC is an insurance quote or contract.

30. The method of claim 28, further comprising:
receiving a request from an administration-level user to change user information included in a set of user information;
prompting the administration-level user for modified user information; and
storing the modified user information with the set of user information.

31. The method of claim 28, further comprising:
receiving a request from an administration-level user to add a new user;
prompting the administration-level user for new user information; and
storing the new user information with the one or more sets of user information.

32. The method of claim 28, further comprising:
receiving a request from an administration-level user to view stored information;
causing the stored information to be displayed on a computer operated by the administration-level user.

33. The method of claim 32, wherein the request includes a request for one or more insurance codes.

34. The method of claim 32, wherein the request includes a request for state-specific insurance information.

35. The method of claim 32, wherein the request includes a request for information describing application activity for one or more of the users of the online application system.

36. A method performed by a first computer comprising:
sending application information to a second computer, where the application information includes information pertaining to a potential customer of a provider of a product, wherein sending the application information causes the second computer to decide, based on the application information and one or more electronically-stored rule sets, whether or not to generate an application review communication (ARC) for the potential customer, which describes terms under which the product is offered, and sending the application information further causes the second computer to automatically generate and store the ARC, if the second computer decides to generate the ARC.

37. The method of claim 36, wherein the product is an insurance product, the one or more electronically-stored rule sets are one or more sets of underwriting criteria, and the ARC is an insurance quote or contract.

38. The method of claim 36, further comprising:
sending the second computer a request to submit the application information;
receiving a message from the second computer in response to the request; and
displaying a first data input screen in accordance with the message, which enables a user of the first computer to enter at least a first portion of the application information.

39. The method of claim 38, further comprising:
displaying one or more additional data input screens, which enable the user of the first computer to enter one or more additional portions of the application information.

40. The method of claim 36, further comprising:
receiving a denial message from the second computer if the second computer decides, based on the application information and the one or more electronically-stored rule sets, whether or not to automatically deny the potential customer; and
displaying the denial message.

41. A method comprising:
receiving application information, where the application information includes information pertaining to a potential customer of a provider of a product;
deciding, based on the application information and one or more electronically-stored rule sets, whether or not to generate an application review communication (ARC) for the potential customer, which describes terms under which the product is offered; and
if a decision is made to generate the ARC, automatically generating and storing the ARC.

42. The method of claim 41, wherein the product is an insurance product, the one or more electronically-stored rule sets are one or more sets of underwriting criteria, and the ARC is an insurance quote or contract.

43. The method of claim 1, further comprising:
receiving a request to submit the application information; and
in response to the request, causing a computer to display a first data input screen, which enables a user of the computer to enter at least a first portion of the application information.

44. The method of claim 43, further comprising:
determining whether additional application information is necessary; and
if the additional application information is necessary, causing the computer to display one or more additional data input screens, which enable the user of the computer to enter one or more additional portions of the application information.

45. The method of claim 41, further comprising:
deciding, based on the application information and the one or more electronically-stored rule sets, whether or not to automatically deny the potential customer; and
if a decision is made to automatically deny the potential customer, sending a denial message.

46. The method of claim 41, further comprising:
deciding, based on the application information and the one or more electronically-stored rule sets, whether or not to enter a manual approval process; and
if a decision is made to enter the manual approval process, sending a manual approval message to a designated individual.

47. The method of claim 41, further comprising:
sending the ARC in an electronic communication.

48. A first computer comprising:
a network interface, wherein the network enables the first computer to communicate with one or more other computers; and
at least one processor, which sends application information to a second computer, where the application information includes information pertaining to a potential customer of a provider of a product, wherein sending the application information causes the second computer to decide, based on the application information and one or more electronically-stored rule sets, whether or not to generate an application review communication (ARC) for the potential customer, which describes terms under which the product is offered, and sending the application information further causes the second computer to automatically generate and store the ARC, if the second computer decides to generate the ARC.

49. The first computer of claim 48, wherein the product is an insurance product, the one or more electronically-stored rule sets are one or more sets of underwriting criteria, and the ARC is an insurance quote or contract.

50. The first computer of claim 48, wherein the at least one processor further sends the second computer a request to submit the application information, receives a message from the second computer in response to the request, and displays a first data input screen in accordance with the message, which enables a user of the first computer to enter at least a first portion of the application information.

51. The first computer of claim 50, wherein the at least one processor further displays one or more additional data input screens, which enable the user of the first computer to enter one or more additional portions of the application information.

52. The first computer of claim 48, wherein the at least one processor further receives a denial message from the second computer if the second computer decides, based on the application information and the one or more electronically-stored rule sets, whether or not to automatically deny the potential customer, and the first computer displays the denial message.

53. A second computer comprising:
a network interface, wherein the network enables the second computer to communicate with one or more other computers; and
at least one processor, which receives application information, where the application information includes information pertaining to a potential customer of a provider of a product, decides, based on the application information and one or more electronically-stored rule sets, whether or not to generate an application review communication (ARC) for the potential customer, which describes terms under which the product is offered, and if a decision is made to generate the ARC, automatically generates and stores the ARC.

54. The second computer of claim 53, wherein the product is an insurance product, the one or more electronically-stored rule sets are one or more sets of underwriting criteria, and the ARC is an insurance quote or contract.

55. The second computer of claim 53, wherein the at least one processor further receives a request to submit the application information, and in response to the request, causes a first computer to display a first data input screen, which enables a user of the first computer to enter at least a first portion of the application information.

56. The second computer of claim 55, wherein the at least one processor further determines whether additional application information is necessary, and if the additional application information is necessary, the processor causes the first computer to display one or more additional data input screens, which enable the user of the first computer to enter one or more additional portions of the application information.

57. The second computer of claim 53, wherein the at least one processor further decides, based on the application information and the one or more electronically-stored rule sets, whether or not to automatically deny the potential customer, and if a decision is made to automatically deny the potential customer, the at least one processor sends a denial message.

58. The second computer of claim 53, wherein the at least one processor further decides, based on the application information and the one or more electronically-stored rule sets, whether or not to enter a manual approval process, and if a decision is made to enter the manual approval process, the at least one processor sends a manual approval message to a designated individual.

59. The second computer of claim 53, wherein the at least one processor further sends the ARC in an electronic communication.

60. A computer readable medium having communications thereon for providing a client computer with information for handling an application for a potential customer of a provider of a product, the communications comprising:
one or more application information input pages, which enable a user of the computer to enter and submit application information that includes information pertaining to a potential customer of a provider of a product, wherein the application information is useable by a server computer to decide, based on the application information and one or more electronically-stored rule sets, whether or not to generate an application review communication (ARC) for the potential customer, which describes terms under which the product is offered, and if a decision is made to generate the ARC, the application information is useable by the server to automatically generate and store the ARC.

61. The computer readable medium as claimed in claim 60, wherein the computer readable medium includes a carrier wave that transports information.

62. The computer readable medium as claimed in claim 60, wherein the computer readable medium includes the Internet.

63. The computer readable medium as claimed in claim 60, wherein the computer readable medium includes a network.
